(19) United States
(12) Patent Application Publication
(10) Pub. No.: US 2006/0076164 A1
(43) Pub. Date: Apr. 13, 2006

(54) Weight sensor and occupant detecting system

(75) Inventor: Eiichi Nishio, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/231,923

(22) Filed: Sep. 22, 2005

(30) Foreign Application Priority Data
Sep. 30, 2004 (JP) 2004-285790

(51) Int. Cl. G01G 19/08; A47C 31/00; G08B 21/00; G01B 7/14

(52) U.S. Cl. 177/136; 297/463.1; 340/667; 324/207.11

(57) ABSTRACT

A weight sensor for detecting an occupant seated on a seat includes a long and narrow sensing member having a floor side fixing portion disposed at one end, a seat side fixing portion at the other end and a sensing portion disposed between the floor side fixing portion and the seat side fixing portion and plural strain gages disposed on the sensing portion. The sensing member has stress concentration steps between the floor side fixing portion and the sensing portion and between the seat side fixing portion and the sensing portion. The floor side fixing portion is directly fastened to a seat rail fixed to a floor by fastening bolts, and the seat side fixing portion is directly fastened to a seat frame of the seat by fastening bolts.

### CROSS REFERENCE TO RELATED APPLICATION

The present application is based on and claims priority from Japanese Patent Application 2004-285790, filed Sep. 30, 2004, the contents of which are incorporated herein by reference.

### BACKGROUND OF THE INVENTION

1. Field of the Invention

The present invention relates to a weight sensor for use in a seat occupant detecting system.

2. Description of the Related Art

A seat occupant detecting system includes plural weight sensors and an ECU (electronic control unit). Usually, weight sensors are disposed between a seat frame and a seat rail of a vehicle seat, as disclosed in JP-A-2003-287458. As shown in FIGS. 8A and 8B, each weight sensor includes a flat sensing member 108, a bridge circuit 102 formed on a flexible printed-circuit-board 103, four strain gages 102a, 101b, 101c, 101d soldered to the printed circuit board 103, a wire 104, a connector 105 and an amplifier 106. The bridge circuit 102 is also connected to the amplifier 106 via the connector 105, which is connected to a passenger detecting ECU via a wire harness.

The flat sensing member 108 has one end 108a sandwiched and compressed by a pair of floor side fixing members 110a, 110b and a pair of bolts 109a, 109b. The floor side fixing members 110a, 110b are fixed by bolts 112a, 112b to a portion of a vehicle floor. The other end 108b of the flat sensing member 108 is sandwiched and compressed by a pair of seat side fixing members 113a, 113b and a pair of bolts 114a, 114b. The seat side fixing members 113a, 113b are fixed to a portion 117 of the seat by a bolt 116. One 113a of the seat side fixing members is a cantilever, whose one end is disposed where an occupant is seated so that a weight (indicated by an arrow) of the occupant can be transmitted to the other end 108b of the sensing member.

Because the fixing members 110a, 110b, 113a, 113b include many parts as well as the cantilever, it takes a long time to fix the weight sensors to a vehicle. Further, because the opposite ends of the flat sensing member are sandwiched by the fixing members 110a, 110b, 113a, 113b under compression, the flat sensing member 108 may be subject to fretting corrosion when a weight is repeatedly applied thereto.

### SUMMARY OF THE INVENTION

Therefore, an object of the invention is to provide an improved weight sensor.

Another object of the invention is to provide a simple and compact weight sensor.

According to a feature of the invention, a weight sensor includes a long and narrow sensing member having a floor side fixing portion disposed at one end, a seat side fixing portion at the other end and a sensing portion disposed between the floor side fixing portion and the seat side fixing portion and a plurality of strain gages disposed on the sensing portion. With the above construction, the sensing member includes stress concentration steps between the floor side fixing portion and the sensing portion and between the seat side fixing portion and the sensing portion. The floor side fixing portion is directly fastened to the floor by a plurality of fastening bolts at a prescribed position thereof and the seat side fixing portion is directly fastened to the seat by a plurality of fastening bolts at a prescribed position thereof.

In the above weight sensor, the floor side fixing portion may be fastened to a seat rail, and the seat side fixing member may be fastened to a seat frame. At least the floor side fixing portion or the seat side fixing portion is fastened to the floor at a position remote from the step portion. The seat side fixing member may be fastened in the same direction as the direction in which the sensing portion bends. The floor side fixing member may be fastened in a different direction from the direction in which the sensing portion bends.

The strain gages are preferably disposed on a bottom surface of the sensing portion and connected to a bridge circuit formed on a flexible printed circuit board.

Another object of the invention is to provide an improved occupant detecting system.

According to a feature of the invention, an occupant detecting system includes the improved weight sensor and an occupant detecting ECU that finds out a seat occupant according to signals of the weight sensor. In this occupant detecting system, the occupant detecting ECU includes a multiplexer for providing a multiplex signal from the signals of the weight sensors and means for converting the multiplex signal to a digital signal. The occupant detecting ECU may otherwise include an amplifier for amplifying the signals of the weight sensors and means for converting the amplified signals to a digital signal.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a schematic perspective view of a seat in which an occupant detecting system according to the first embodiment of the invention is equipped;

FIG. 2 is a block diagram of the occupant detecting system shown in FIG. 1;

FIG. 3A is a cross-sectional side view of a weight sensor of the occupant detecting system according to the first embodiment, and FIG. 3B is a bottom plan view of the above weight sensor;

FIG. 4 is a wiring diagram of the weight sensor shown in FIG. 3B;

FIG. 5 is a cross-sectional side view of a modified weight sensor of the occupant detecting system according to the first embodiment of the invention;

FIG. 6A is a cross-sectional side view of a weight sensor of the occupant detecting system according to the second embodiment, and FIG. 6B is a bottom plan view of the above weight sensor;

FIG. 7 is a block diagram of the occupant detecting system according to the third embodiment of the invention; and

FIGS. 8A and 8B are respectively a cross-sectional side view and a bottom plan view of a prior art weight sensor.

### DETAILED DESCRIPTION OF THE PREFERRED EMBODIMENTS

Some preferred embodiments of the present invention will be described with reference to the appended drawings.

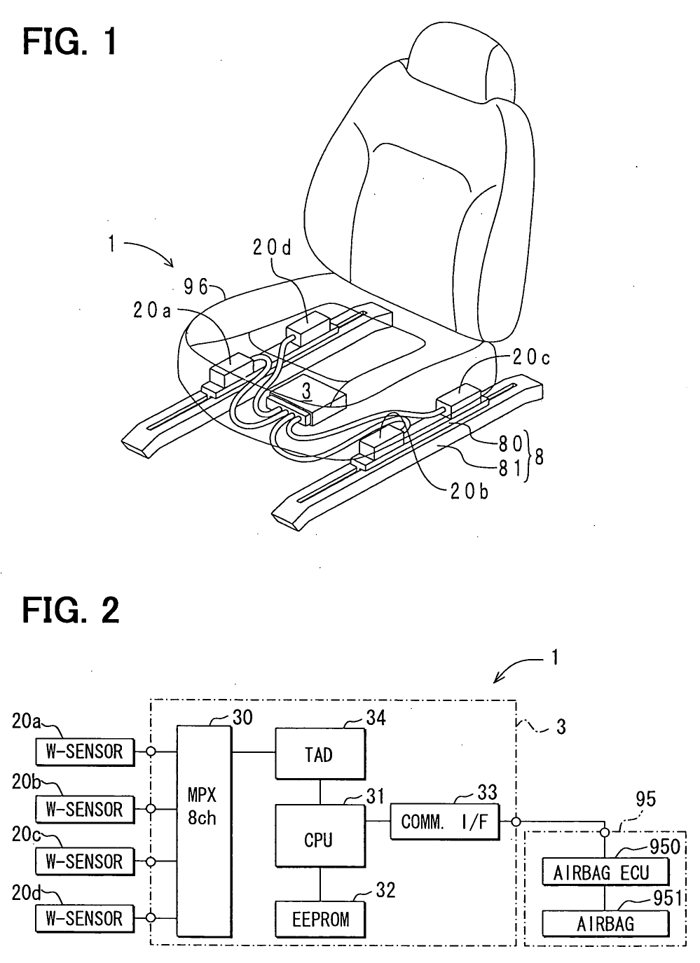

An occupant detecting system according to the first embodiment of the invention will be described with reference to FIGS. 1-5.

As shown in FIG. 1, the occupant detecting system is mounted in the front passenger's seat 96 of a vehicle, which is mounted on a pair of seat rails 8. Each seat rail 8 is comprised of an upper rail 80 and a lower rail 81. The pair of seat rails 8 is fixed to the floor of a vehicle to line up in the transverse or width direction of the vehicle body. The upper rail 80 is slidably disposed on the lower rail 81 and fixed to the seat 96 so that the seat 96 can slide back and forth along the lower rail 81. The occupant detecting system 1 includes four weight sensors—a front right sensor 20a, a front left sensor 20b, a rear left sensor 20c and a rear right sensor 20d—and an occupant detecting ECU 3, which are electrically connected to the weight sensors by wire harnesses.

The seat 96 has a seat frame (not shown), and the four weight sensors 20a, 20b, 20c, 20d are disposed between the seat frame and the upper rail 80. Each weight sensor is a strain gage type sensor that includes a bridge circuit and a pair of strain gages. Occupant detecting ECU 3 is fixed to the bottom of the seat 96 in the middle of the width thereof.

As shown in FIG. 2, occupant detecting ECU 3 includes a multiplexer 30, CPU (central processing unit) 31, EEPROM 32, communication I/F (interface) 33 and TAD (propagation time analog to digital converter) 34. The four weight sensors 20a, 20b, 20c, 20d are connected to the multiplexer 30 to give the same their analog output signals. The multiplexer 30 timeshares the analog signals to provide an analog multiplex signal. In more detail, the multiplexer 30 provides a selection signal that synchronizes with a crock signal of TAD 34 to select the analog output signals sent from the weight sensors 20a, 20b, 20c, 20d, thereby forming the multiplex signal. No amplifier is necessary for the weight sensors 20a and occupant detecting ECU 3, and, hence, the size of the weight sensors 20a, 20b, 20c, 20d, can be made compact.

The multiplexer 30 sends TAD 34 the multiplex signal. TAD 34 has a signal-propagation-time-effect to form a binary-coded digital signal from the multiplex signal in such a way that a start pulse propagates and circulates a ring counter that is comprised of series-connected sixteen CMOS inverters at a propagation speed that is proportional to the analog multiplex signal. The final stage of the CMOS inverter provides output signals, which are counted by a sixteen-bit binary counter. The output signal of the binary counter is inputted into a first latch circuit and sampled by a clock pulse to form a fourteen-bit binary code of higher digits. When the output signal of the binary counter is sampled, the position of one of the CMOS inverters at which the start pulse arrives is inputted into a second latch circuit as a binary code. The output signal of the second latch circuit is also sampled by the clock pulse to form a four-bit binary code of lower digits. Thus, eighteen-bit binary code that corresponds to the analog multiplex signal is provided.

CPU 31 receives the digital signal from TAD 34. CPU 31 includes a RAM and a ROM. The RAM temporally stores the digital signal sent from TAD 34. The ROM stores a seat occupant detecting program and related data such as a threshold level for detecting a seat occupant beforehand. CPU 31 executes the occupant detecting program and judges whether an occupant is seated or not. EEPROM 32 stores various correction data such as a temperature correcting value. Communication I/F 33 transmits the operation result of CPU 31 to airbag ECU 950 of an airbag system 95 (shown in FIG. 2). Airbag ECU 950 activates or deactivates an air bag 951 according to the operation result of CPU 31.

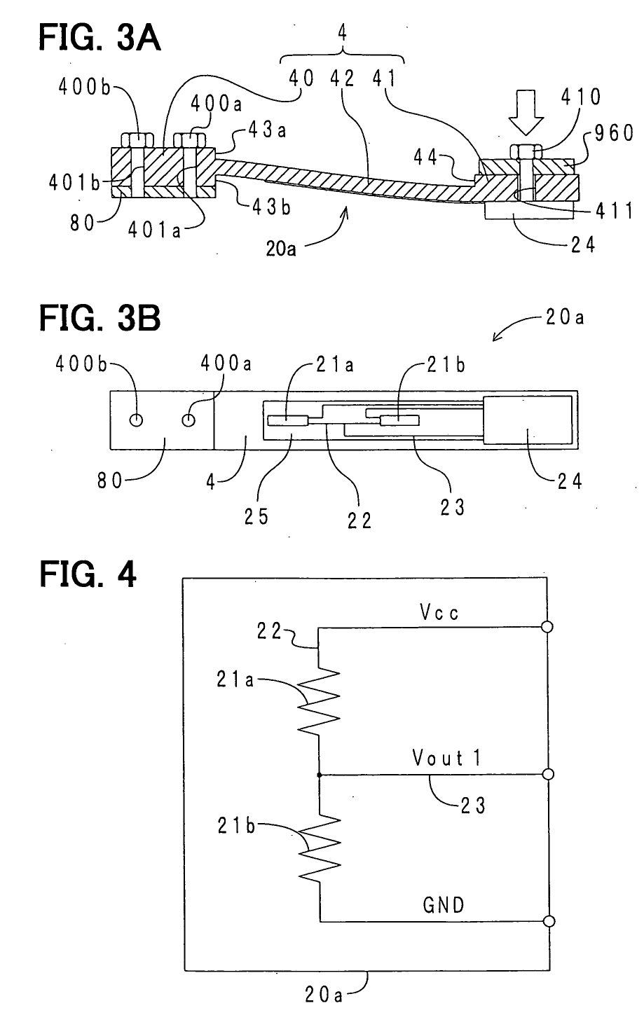

As shown in FIGS. 3A and 3B, the weight sensor 20a includes a metal sensing member 4, a pair of strain gages 21a, 21b, a bridge circuit 22, signal transmission wires 23, a connector 24 and a flexible printed circuit (hereinafter referred to as FPC) 25. The strain gages 21a, 21b, the bridge circuit 22, the wires 23 and the connector 24 are formed on FPC 25. Therefore, relative distances between the strain gages 21a, 21b, the signal transmission wires 23 and the connector 24 can be accurately set. The bridge circuit 22 and the transmission wires 23 are formed from a copper foil by precision etching. The connector 24 is connected to ECU 3. FPC 25, together with the strain gages 21a, 21b, the bridge circuit 22, the signal transmission wires 23 and the connector 24, is fixed on the bottom surface of the sensing member 4. Therefore, very short assembling time is only necessary.

The sensing member 4 is a long and narrow metal member that is comprised of a floor side fixing portion 40, a seat side fixing portion 41 and a sensing portion 42. In other words, the fixing portions 40, 41 are integrated with the sensing portion 42. The floor side fixing portion 40 is disposed at the front end of the sensing member 4, and the seat side fixing portion 41 is disposed at the rear end of the sensing member 4. The sensing portion 42 is disposed between the fixing portions 40 and 41. FPC 25 is disposed on the bottom surface of the sensing portion 42.

The floor side fixing portion 40 is directly fastened to an upper rail 80 by fastening bolts 400a, 400b via through holes 401a, 401b, and the seat fixing portion 41 is directly fastened to a seat frame 960 by a fastening bolt 410 via a through hole 411. Therefore, it is easy to fix the weight sensors 20a, 20b, 20c, 20d to the upper rail and the seat frame.

The thickness of the floor side fixing portion 40 is larger than the sensing portion 42, so that stress concentration steps 43a, 43b are respectively formed on the upper and bottom surfaces of the sensing member 4 between the floor side fixing portion 40 and the sensing portion 42. The thickness of the seat side fixing portion 41 is also larger than the sensing portion 42, so that a stress concentration step 44 is formed on the upper surface of the sensing member 4 between the seat side fixing portion 41 and the sensing portion 42.

The fastening force for fastening the sensing member 4 to the upper rail 80 is applied to the floor side fixing portion 40, while the bending force caused by the occupant weight is applied to the stress concentration steps 43a, 43b that are apart from the fastened portions of the floor side fixing portion 40. Because the thickness of the floor side fixing portion 40 is much larger than the sensing portion 42, the strain of the floor side fixing portion 40 is much smaller than the sensing portion 42. Therefore, the fretting corrosion can be effectively prevented.

The fastening force for fastening the sensing member 4 to the seat frame 960 is applied to the seat side fixing portion 41, while the bending force caused by the occupant weight is applied to the stress concentration step 44 that is apart from the fastened portions of the seat side fixing portion 41. Because the thickness of the seat side fixing portion 41 is much larger than the sensing portion 42, the strain of the seat side fixing portion 41 is much smaller than the sensing portion 42. Therefore, the fretting corrosion can be also effectively prevented.

As shown in FIG. 4, the strain gages 21a, 21b and the bridge circuit 22 form a half bridge circuit. The bridge circuit 22 is connected to a 5V-electric source Vcc of occupant detecting ECU 3 by the first one of the wires 23 and to a ground GND by the second one of the wires 23. The third signal transmission wire 23 is connected to the junction of the series connected strain gages 21a and 21b to take out a signal voltage Vout1 from the strain gages 21a, 21b. Other weight sensors 20b, 20c, 20d have the same construction and function as above weight sensor 20a.

When some one is seated on the passenger's seat 96, weights are respectively applied to the weight sensors 20a, 20b, 20c, 20d to bend the sensing members 4. For example, when the sensing member 4 of the front right weight sensor 20a bends, the resistances of the strain gages 21a, 21b respectively change, so that the signal voltage Vout 1, which is a divided voltage of Vcc, changes. The signal voltages from all the weight sensors 20a, 20b, 20c, 20d are sent to the multiplexer 30. The multiplexer 30 forms a multiplex signal, which is inputted into TAD 34. TAD 34 converts the multiplex signal into digital signals, which are temporally stored in a RAM of CPU 31. The digital signals that are stored in the RAM are added by CPU 31 to have a total sum, which is compared with a child occupant detecting threshold value and adult occupant detecting threshold value, both of which are stored in the ROM.

If the total sum is less than the child occupant threshold value, it is presumed that no one is seated. If the total sum is larger than the child occupant threshold value and less than the adult occupant threshold value, it is presumed that a child is seated. If the total sum is larger than the adult occupant threshold value, it is presumed that an adult occupant is seated. The comparison result is sent to air bag ECU 950, which sends a command signal to airbag ECU 950. Airbag ECU 950 renders the air bag 951 to keep alert if an adult occupant is found to be seated or to deactivate if no occupant but a child is found to be seated.

If a weight is applied to the seat side fixing portion as indicated by an arrow in FIG. 3, the sensing portion 42 of the sensing member 4 bends downward from the stress concentration steps 43a, 43b and upward from the stress concentration step 44. Accordingly, a compression stress is applied to the strain gage 21a and a tensility is applied to the strain gage 21b.

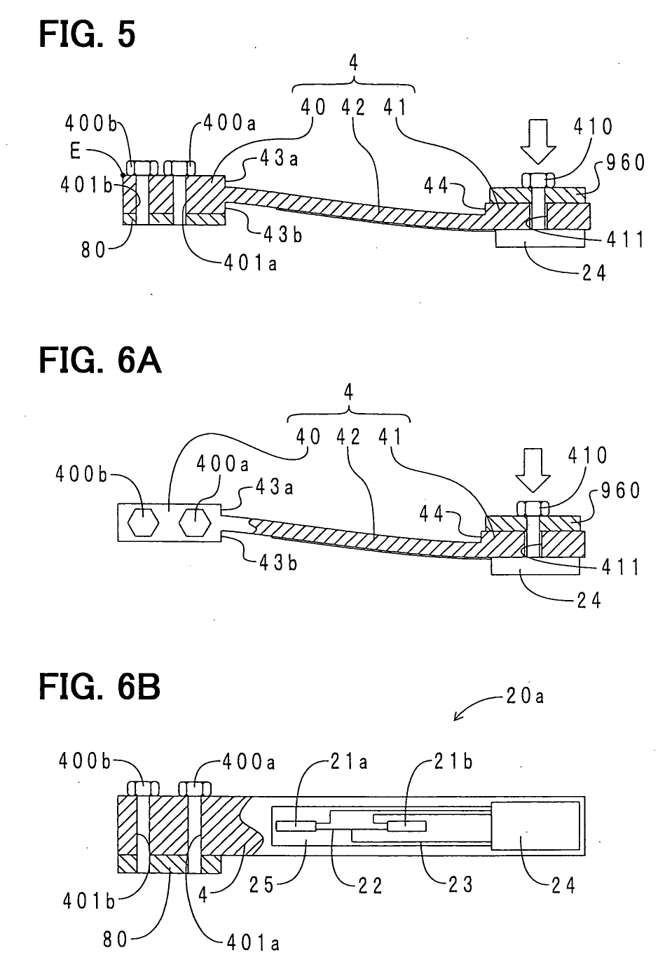

As shown in FIG. 5, the floor side fixing portion 40 may have through holes 401a, 401b formed more remote from the step portions 43a, 43b. That is, the fixing portion 40 is fastened to an upper rail 80 by fastening bolts 400a, 400b at a side of the fixing portion 40 remote from the step portions 43a, 43b. Therefore, the fretting corrosion can be prevented more effectively.

An occupant detecting system according to the second embodiment of the invention will be described with reference to FIGS. 6A and 6B. Incidentally, the same reference numeral as the first embodiment hereafter indicates the same or substantially the same part, portion or composition as the first embodiment.

The floor side fixing portion 40 is fastened to a side of the upper rail 80 by fastening bolts 400a, 400b via through holes 401a, 401b, while the seat fixing portion 41 is fastened to the seat frame 960 in the same manner as the first embodiment. Therefore, the fastening force caused by the fastening bolts and the bending force caused by the occupant weight are different in direction from each other. This effectively prevents the fretting corrosion.

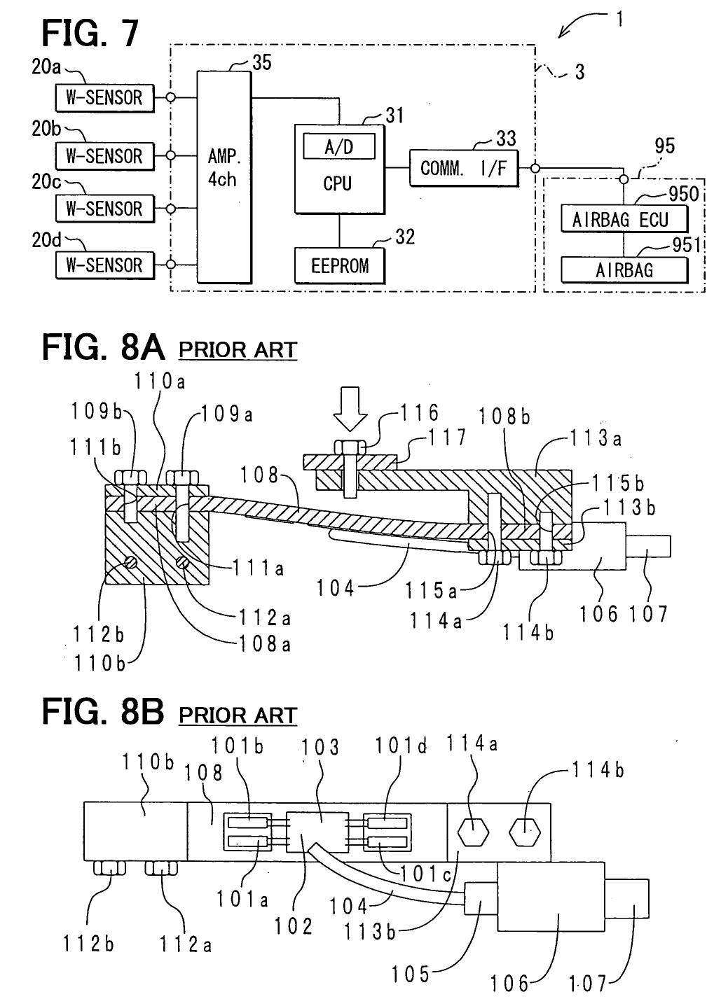

An occupant detecting system according to the third embodiment of the invention will be described with reference to FIG. 7.

As shown in FIG. 7, occupant detecting ECU 3 includes CPU 31, EEPROM 32, communication I/F and an amplifier 35 that amplifies analog signals sent from the weight sensors 20a, 20b, 20c, 20d. CPU 31 includes an A/D converter, which converts the amplified analog signals into digital signals. This occupant detecting ECU 3 operates substantially in the same manner as the first embodiment.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A weight sensor for detecting a weight applied to a seat that is disposed on a floor, said weight sensor comprising:
a long and narrow sensing member having a floor side fixing portion disposed at one end, a seat side fixing portion at the other end and a sensing portion disposed between said floor side fixing portion and said seat side fixing portion; and
a plurality of strain gages disposed on said sensing portion; wherein:
said sensing member comprises stress concentration steps between said floor side fixing portion and said sensing portion and between said seat side fixing portion and said sensing portion;
said floor side fixing portion is directly fastened to the floor by a plurality of fastening bolts at a prescribed position thereof; and
said seat side fixing portion is directly fastened to the seat by a plurality of fastening bolts at a prescribed position thereof.

2. The weight sensor as claimed in claim 1, wherein;
the floor includes a seat rail to which said floor side fixing portion is fastened; and
the seat includes a seat frame to which said seat side fixing member is fastened.

3. The weight sensor as claimed in claim 1, wherein at least one of said floor side fixing portion and said seat side fixing portion is fastened to the floor at a position remote from said step portion;

4. The weight sensor as claimed in claim 1, wherein said seat side fixing member is fastened in the same direction as the direction in which said sensing portion bends.

5. The weight sensor as claimed in claim 1, wherein at least one of said floor side fixing member and said seat side fixing member is fastened in a different direction from the direction in which said sensing portion bends.

6. The weight sensor as claimed in claim 1, wherein said strain gages are disposed on a bottom surface of said sensing portion.

7. The weight sensor as claimed in claim 6, further comprising a bridge circuit formed on a flexible printed circuit,
wherein said strain gages are connected to said bridge circuit.

8. The weight sensor as claimed in claim 7, wherein said strain gages are disposed on said flexible printed circuit.

9. The weight sensor as claimed in claim 7, wherein said flexible printed circuit includes a signal transmission wire connected to said bridge circuit.

10. The weight sensor as claimed in claim 9, further comprising a connector disposed on said flexible printed circuit.

11. An occupant detecting system including the weight sensor claimed in claim 1 and an occupant detecting ECU that finds out a seat occupant according to signals of the weight sensor,
wherein said occupant detecting ECU comprises a multiplexer for providing a multiplex signal from the signals of the weight sensors; and
means for converting the multiplex signal to a digital signal at a propagation speed that is proportional to the multiplex signal.

12. An occupant detecting system including the weight sensor claimed in claim 1 and an occupant detecting ECU that finds out a seat occupant according to signals of the weight sensor,
wherein said occupant detecting ECU comprises an amplifier for amplifying the signals of the weight sensors; and
means for converting the amplified signals to a digital signal at a propagation speed that is proportional to the multiplex signal.
